(19) United States
(12) Patent Application Publication
(10) Pub. No.: US 2023/0393586 A1
(43) Pub. Date: Dec. 7, 2023

(54) CONTROL SYSTEMS AND METHODS FOR AUTONOMOUS MOBILE ROBOT SWARM

(71) Applicant: GM GLOBAL TECHNOLOGY OPERATIONS LLC, Detroit, MI (US)

(72) Inventors: Xiang ZHAO, Novi, MI (US); Thiagarajan Chidambareswaran, Sterling Heights, MI (US)

(21) Appl. No.: 17/831,739

(22) Filed: Jun. 3, 2022

(51) Int. Cl. G05D 1/02; G05D 1/00

(52) U.S. Cl. CPC G05D 1/0287; G05D 1/0088; G05D 1/0231

(57) ABSTRACT

A control system includes: a command module configured to generate first linear and angular velocity commands for a follower autonomous mobile robot (AMR); an error module configured to: generate a first error for the follower AMR between the first linear velocity command and a present velocity of the follower AMR; and generate a second error for the follower AMR between the first angular velocity command and a present angular velocity of the follower AMR; a proportional integral (PI) module configured to: generate a second linear velocity command for the follower AMR based on the first error using PI control; and generate a second angular velocity command for the follower AMR based on the second error using PI control; and a driver module configured to apply power to one or more electric motors of the follower AMR based on the second linear velocity command and the second angular velocity command.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to autonomous mobile robots and more particularly to control systems and methods for autonomous mobile robot swarms.

Broadly speaking, an autonomous mobile robot (AMR) is a robot that can understand and move through its environment without being overseen directly by an operator or on a fixed predetermined path. AMRs may include an array of sensors that enable them to understand and interpret their environment, which helps them to perform their task in the most efficient manner and path possible, navigating around fixed obstructions (building, racks, work stations, etc.) and variable obstructions (such as humans, lift trucks, and debris).

Though similar in many ways to automated guided vehicles (AGVs), AMRs differ in a number of important ways. The greatest of these differences may be flexibility. AGVs may follow more rigid, preset routes than AMRs. AMRs may find a most efficient route to achieve each task, and may be designed to work collaboratively with operators such as picking and sortation operations, whereas AGVs may not.

### SUMMARY

In a feature, a control system for one or more autonomous mobile robots includes: a command module configured to generate a first linear velocity command and a first angular velocity command for a follower autonomous mobile robot (AMR) of a swarm of two or more AMRs including at least the follower AMR and a leader AMR; an error module configured to: generate a first error for the follower AMR between the first linear velocity command and a present velocity of the follower AMR; and generate a second error for the follower AMR between the first angular velocity command and a present angular velocity of the follower AMR; a proportional integral (PI) module configured to: generate a second linear velocity command for the follower AMR based on the first error using PI control; and generate a second angular velocity command for the follower AMR based on the second error using PI control; and a driver module configured to apply power to one or more electric motors of the follower AMR based on the second linear velocity command and the second angular velocity command.

In further features, the command module is configured to generate at least one of the first linear velocity command and the first angular velocity command based on distances between positions of the leader AMR and a positions of the follower AMR.

In further features, the command module is configured to generate at least one of the first linear velocity command and the first angular velocity command further based on a difference between a heading angle of the leader AMR and a heading angle of the follower AMR.

In further features, a position module is configured to determine the positions of the follower AMR using a light detection and ranging (LIDAR) sensor.

In further features, sensors are configured to measure the present angular velocity of the follower AMR and the present linear velocity of the follower AMR.

In further features, the leader AMR includes a second driver module configured to apply power to one or more electric motors of the leader AMR based on predetermined linear and angular velocity commands.

In further features, the leader AMR includes a second driver module configured to apply power to one or more electric motors of the leader AMR based on following a predetermined path.

In further features, the leader AMR includes: a second error module configured to: generate a third error for the leader AMR between a third linear velocity command and a present velocity of the leader AMR; and generate a fourth error for the leader AMR between a third angular velocity command and a present angular velocity of the leader AMR; a second PI module configured to: generate a fourth linear velocity command for the leader AMR based on the third error using PI control; and generate a fourth angular velocity command for the follower AMR based on the fourth error using PI control; and a second driver module configured to apply power to one or more electric motors of the follower AMR based on the fourth linear velocity command and the fourth angular velocity command.

In further features, the leader AMR further includes a leader velocity module configured to generate the third linear velocity command for the leader AMR and the third angular velocity command for the leader AMR.

In further features, the leader velocity module is configured to generate the third linear velocity command and the third angular velocity command based on predetermined linear and angular velocity commands.

In further features, the leader velocity module is configured to generate the third linear velocity command and the third angular velocity command based on following a predetermined path.

In a feature, a control method for one or more autonomous mobile robots includes: generating a first linear velocity command and a first angular velocity command for a follower autonomous mobile robot (AMR) of a swarm of two or more AMRs including at least the follower AMR and a leader AMR; generating a first error for the follower AMR between the first linear velocity command and a present velocity of the follower AMR; generating a second error for the follower AMR between the first angular velocity command and a present angular velocity of the follower AMR; generating a second linear velocity command for the follower AMR based on the first error using proportional integral (PI) control; generating a second angular velocity command for the follower AMR based on the second error using PI control; and applying power to one or more electric motors of the follower AMR based on the second linear velocity command and the second angular velocity command.

In further features, the control method further includes generating at least one of the first linear velocity command and the first angular velocity command based on distances between positions of the leader AMR and a positions of the follower AMR.

In further features, the control method further includes generating at least one of the first linear velocity command and the first angular velocity command further based on a difference between a heading angle of the leader AMR and a heading angle of the follower AMR.

In further features, the control method further includes determining the positions of the follower AMR using a light detection and ranging (LIDAR) sensor.

In further features, the control method further includes measuring the present angular velocity of the follower AMR and the present linear velocity of the follower AMR using sensors.

In further features, the control method further includes applying power to one or more electric motors of the leader AMR based on predetermined linear and angular velocity commands.

In further features, the control method further includes applying power to one or more electric motors of the leader AMR based on following a predetermined path.

In further features, the control method further includes: generating a third error for the leader AMR between a third linear velocity command and a present velocity of the leader AMR; generating a fourth error for the leader AMR between a third angular velocity command and a present angular velocity of the leader AMR; generating a fourth linear velocity command for the leader AMR based on the third error using PI control; generating a fourth angular velocity command for the follower AMR based on the fourth error using PI control; and applying power to one or more electric motors of the follower AMR based on the fourth linear velocity command and the fourth angular velocity command.

In further features, the control method further includes generating the third linear velocity command for the leader AMR and the third angular velocity command for the leader AMR.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed

description and the accompanying drawings, wherein:

FIG. 1 is a functional block diagram of an example mobile robot swarm;

FIG. 2 is a functional block diagram of an example implementation of an autonomous mobile robot;

FIG. 3 is an example graph of various parameters used to control at least one of a follower autonomous mobile robot (AMR) and a leader AMR;

FIG. 4 is a functional block diagram of an example implementation of a motor control module of the follower AMR;

FIG. 5 is a functional block diagram of an example control system for the leader ARM 104 and the follower ARM;

FIG. 6 is a flowchart depicting an example method of controlling the follower AMR;

FIG. 7 is a flowchart depicting an example method of controlling the leader and follower AMRs; and

FIG. 8 includes example graphs of linear velocity and angular velocity as a function of traveling distance.

In the drawings, reference numbers may be reused to identify similar and/or identical elements.

### DETAILED DESCRIPTION

An autonomous mobile robot (AMR) swarm includes two or more AMRs. Controllers for AMRs may work in simulated environments but may not work well in real world environments where variations are observed in a follower AMRs travel with respect to a leader AMR. Maintenance of a predetermined formation of the AMRs may not be attainable in real world environments.

The present application involves improved control of a follower AMR to provide better maintenance of the predetermined formation during operation in a real world environment. The controller of the leader AMR may also be adapted for better maintenance of the predetermined formation with the follower AMR.

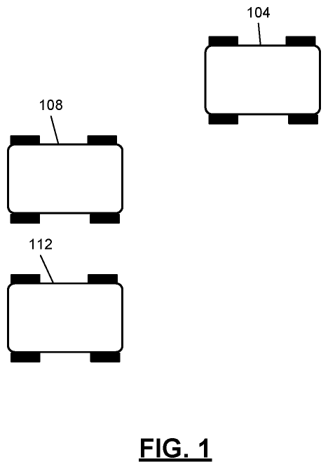

FIG. 1 includes a functional block diagram of an example autonomous mobile robot (AMR) swarm. The mobile robot swarm includes a leader AMR 104 and one or more follower AMRs, such as 108 and 112. While the example of two follower AMRs is illustrated, the present application is applicable to only one follower AMR and to more than two follower AMRs.

The leader AMR 104 is configured to navigate to a goal position and orientation, such as within a building (e.g., a manufacturing facility). The follower AMR 108 is configured to follow the leader AMR 104 and to maintain a predetermined relationship (distance, heading angle, etc.) between itself and the leader AMR 104. For example, two or more AMRs (a leader AMR and one or more follower AMRs) may be used together to move a larger object within the building. The follower AMR 112 is configured to follow the leader AMR 104 and to maintain a predetermined relationship (distance, heading angle, etc.) between itself and the leader AMR 104. In various implementations, the follower AMR 112 may instead be configured to follow the follower AMR 108 and to maintain a predetermined relationship (distance, heading angle, etc.) between itself and the follower AMR 108.

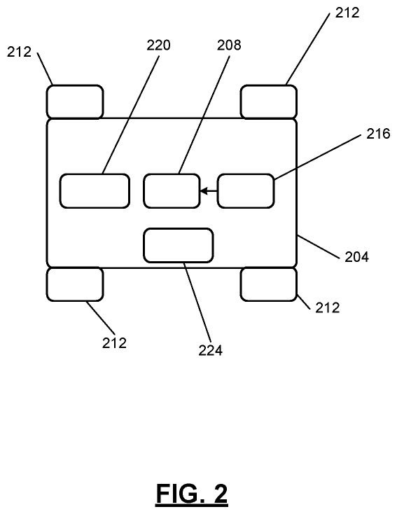

FIG. 2 is a functional block diagram of an example implementation of an AMR 204, such as the leader AMR and the follower AMR. The AMR 204 includes an electric motor 208 that drives one or more wheels of the AMR, such as wheels 212. While the example of four wheels is provided, the AMR 204 may include two or more wheels. Also, while the example of one electric motor is provided, the AMR 204 may include two or more electric motors. For example, one electric motor may be included per wheel to drive that wheel. While the example of wheels is provided, the present application is also applicable to other types of propulsion devices, such as tracks/treads, legs, etc.

A motor control module (MCM) 216 controls power flow from one or more batteries of the AMR 204 to the electric motor 208 to control movement and turning of the AMR 204. A position module 220 determines a present position (e.g., x and y coordinates) of the AMR 204 and heading of the AMR 204, such as within the building. The position module 220 may include, for example, a light detection and ranging (LIDAR) sensor and/or one or more other types of sensors and determine the position and heading of the AMR 204 based on the output of the sensor(s).

A communication module 224 communicates data wirelessly with one or more other devices via one or more antennas. For example, the communication module 224 may communicate its present position and heading to one or more other AMRs, such as in the example of the AMR 204 being a leader AMR. The communication module 224 may receive the present position and heading from one or more other AMRs via one or more antennas, such as in the example of the AMR 204 being a follower AMR.

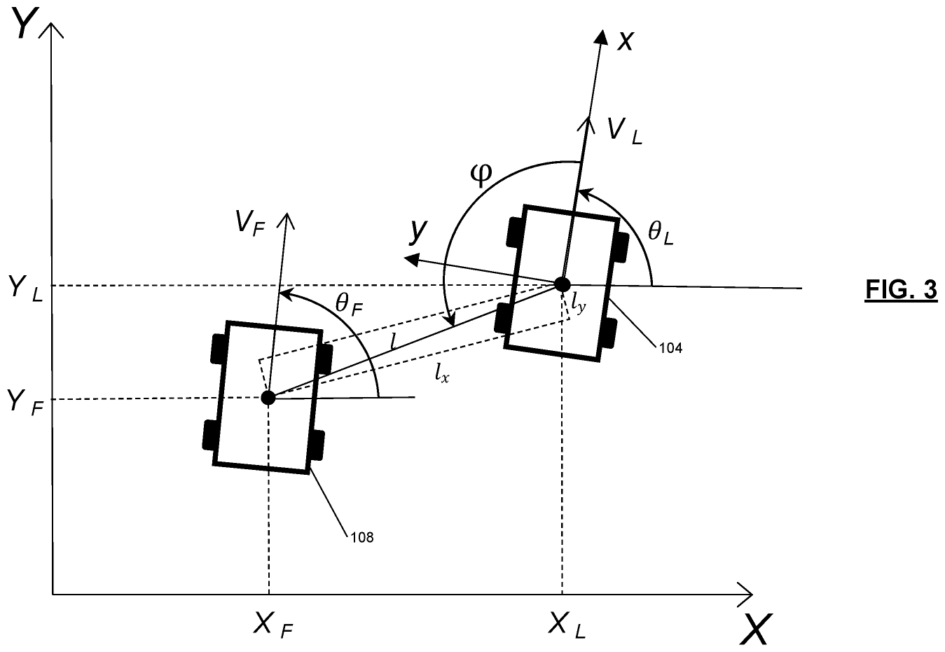

FIG. 3 is an example graph of various parameters used to control at least one of the follower AMR 108 and the leader AMR 104, as discussed further below.

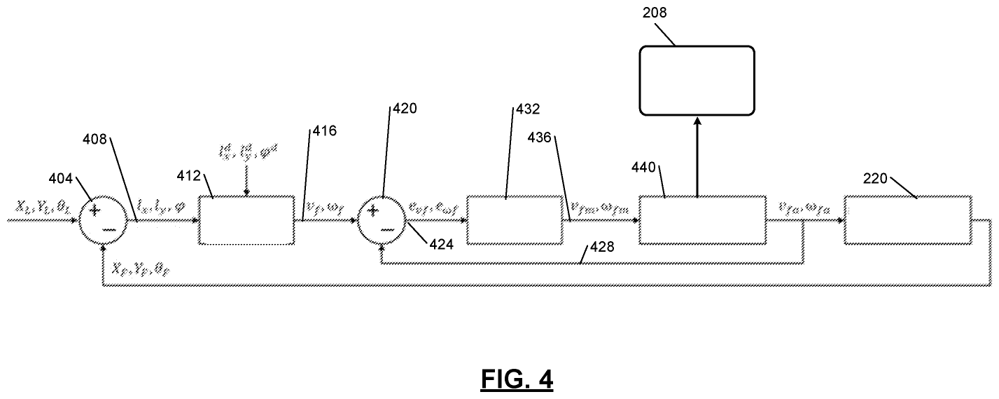

FIG. 4 is a functional block diagram of an example implementation of the MCM 216 of the follower AMR 108. A first error module 404 determines distances and angles 408 between the leader AMR 104 and the follower AMR 108. The first error module 404 determines distances (lₓ, l_{y}) between the leader AMR 104 and the follower AMR 108 in an X-direction based on the present positions of the leader AMR 104 (X_{L}, Y_{L}) and the follower AMR 108 (X_{F}, Y_{F}). The first error module 404 may determine the distances using one or more equations and/or lookup tables. Examples of the distances are shown in FIG. 3.

The first error module 404 determines the angle (φ) between the leader AMR 104 and the follower AMR 108 based on the present heading angles of the leader AMR 104 (θ_{L}) and the follower AMR 108 (θ_{F}). The first error module 404 may determine the angle using one or more equations and/or lookup tables. An example of the angle is shown in FIG. 3.

A command module 412 determines errors (eₓ, e_{y}, e_{θ}) in the follower AMR 108's pose based on the distances (lₓ, l_{y}), target distances (lₓ^{d}, l_{y}^{d}) the angle (φ) and a target angle (φ^{d}). The command module 412 may set the error eₓ based on or equal to the target distance lₓ^{d} minus the distance lₓ. The command module 412 may set the error e_{y} based on or equal to the target distance l_{y}^{d} minus the distance l_{y}. The command module 412 may set the error e_{θ} based on or equal to the target angle φ^{d} minus the angle φ.

The command module 412 generates linear and angular velocity commands v_{f}, ω_{f} based on the errors (eₓ, e_{y}, e_{θ}). The command module 412 generates linear and angular velocity commands v_{f}, ω_{f}, based on adjusting the errors toward or to zero. In other words, the command module 412 generates linear and angular velocity commands v_{f}ω_{f} based on adjusting the distances (lₓ, l_{y}) and the angle (φ) toward or two the target distances (lₓ^{d}, l_{y}^{d}) and the target angle (ω^{d}), respectively. The command module 412 may generate the linear and angular velocity commands v_{f}, ω_{f} for example using feed forward control.

A second error module 420 generates linear and angular velocity errors (e_{vf}, e_{ωf}) 424 based on differences between the linear and angular velocity commands v_{f}, ω_{f}, and actual (present) linear and angular velocities v_{fa}, ω_{fa} 428 of the follower ARM 108. For example, the second error module 420 may set the linear velocity error e_{vf} based on or equal to a difference between the linear velocity command v_{f} and the actual linear velocity v_{fa}. The second error module 420 may set the angular velocity error e_{ωf} based on or equal to a difference between the linear velocity command ω_{f} and the actual linear velocity ω_{fa}.

A proportional integral (PI) module 432 generates adjusted linear and angular velocity commands v_{fm}, ω_{fm} 436 based on the linear and angular velocity errors (e_{vf}, e_{wf}), respectively, using proportional integral control. PI control can be described by the equation

u(t)=Kₚe(t)+Kᵢ∫e(t),

where u(t) is the output, e(t) is the input, and Kₚ and Kᵢ are predetermined proportional and integral gain values. The PI module 432 generates the adjusted linear velocity command based on the linear velocity error using PI control. The PI module 432 generates the adjusted angular velocity command based on the angular velocity error using PI control. The proportional gain Kₚ for the follower AMR may be, for example, 0.2 to 1.5, 0.3 to 1.4, 0.4 to 1.2, or within another suitable range. The integral gain for the follower AMR may be, for example, 0.5% to 12%, 0.75% to 11%, 1% to 10%, or within another suitable range of the proportional gain Kₚ of the follower AMR. These proportional and integral gain values may provide better formation maintenance by the follower AMR than other proportional and integral gain values. The proportional an integral gain values used may be set based on the type of AMRs used.

A driver module 440 applies power to the motor(s) 208 of the follower ARM 108 based on achieving the adjusted linear and angular velocity commands v_{fm}, ω_{fm}, 436. The actual (present) linear and angular velocities v_{fa}, ω_{fa} 428 may be measured using sensors or commanded values from driver module 440. As discussed above, the position module 220 determines the present position of the follower ARM 108.

The above control provides more accurate control of the follower robots angular and linear velocities and more accurately maintains the target distances and angles between the leader ARM 104 and the follower ARM 108. In the example of FIG. 3, the leader ARM 104 may follow a predetermined path (e.g., X and Y coordinates) using predetermined linear and angular speed commands.

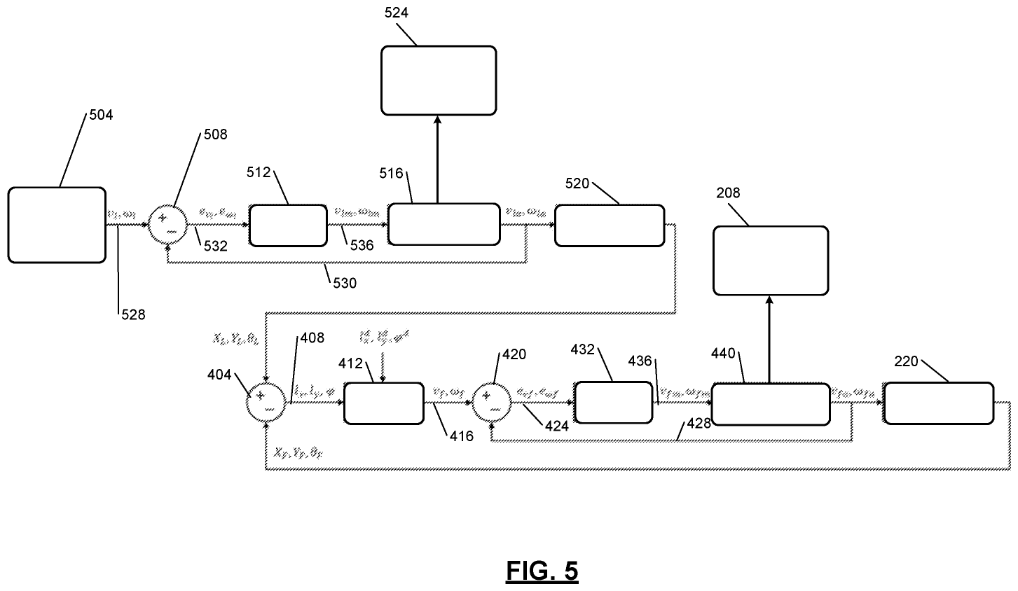

FIG. 5 is a functional block diagram of an example control system for the leader ARM 104 and the follower ARM 108. The functionality of the modules 404, 412, 420, 432, and 440 of the follower ARM 108 are discussed above.

The leader ARM 104 includes a leader velocity module 504, an error module 508, a PI module 512, a driver module 516, a position module 520, and one or more motors 524. The leader velocity module 504 determines linear and angular velocity commands (vₗ, ωₗ) 528 for the leader ARM 104. The linear and angular velocity commands 528 may be predetermined velocities or may be determined by the leader velocity module 504, for example, based on one or more operating parameters, such as objects detected by the position module 520, the present position of the leader ARM 104 and/or one or more other operating parameters.

The error module 508 generates linear and angular velocity errors (eᵥₗ, e_{ωl}) 532 based on differences between the linear and angular velocity commands vₗ, ωₗ and actual (present) linear and angular velocities vₗₐ, ωₗₐ 530 of the leader ARM 104. For example, the error module 508 may set the linear velocity error eᵥₗ based on or equal to a difference between the linear velocity command vₗ and the actual linear velocity vₗₐ. The error module 508 may set the angular velocity error e_{ωl} based on or equal to a difference between the linear velocity command ωₗ and the actual linear velocity ωₗₐ.

The PI module 512 generates adjusted linear and angular velocity commands vₗₘ, ωₜₘ 536 based on the linear and angular velocity errors (eᵥₗ, e_{ωl}), respectively, using proportional integral control. As stated above, PI control can be described by the equation

u(t)=Kₚe(t)+Kᵢ∫e(t),

where u(t) is the output, e(t) is the input, and Kₚ and Kᵢ are predetermined proportional and integral gain values. The PI module 512 generates the adjusted linear velocity command based on the linear velocity error using PI control. The PI module 512 generates the adjusted angular velocity command based on the angular velocity error using PI control. The proportional gain Kₚ for the leader AMR may be, for example, 0.2 to 1.5, 0.3 to 1.4, 0.4 to 1.2, or within another suitable range. The integral gain for the leader AMR may be, for example, 0.5% to 12%, 0.75% to 11%, 1% to less than 10%, or within another suitable range of the proportional gain Kₚ of the leader AMR. These proportional and integral gain values may provide better formation maintenance between the leader and follower AMRs than other proportional and integral gain values. The proportional an integral gain values used may be set based on the type of AMRs used.

The driver module 516 applies power to the motor(s) 524 of the leader ARM 104 based on achieving the adjusted linear and angular velocity commands vₗₘ, ωₗₘ, 536. The actual (present) linear and angular velocities vₗₐ, ωₗₐ, 530 may be measured using sensors or commanded values from driver module 516. As discussed above, the position module 520 determines the present position of the leader ARM 104.

The above control provides more accurate control of the leader and follower ARMs angular and linear velocities and more accurately maintains the target distances and angles between the leader ARM 104 and the follower ARM 108.

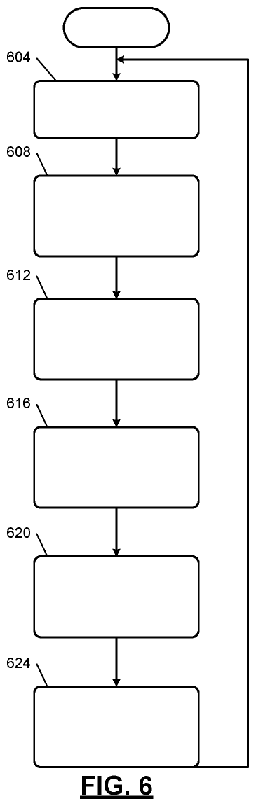

FIG. 6 is a flowchart depicting an example method of controlling the follower AMR 108. Control begins with 604 where the communication module of the follower AMR 108 receives the data of the leader AMR 104 including the leader position and heading.

At 608, the first error module 404 determines the distances and heading angles between the leader AMR 104 and the follower AMR 108, as discussed above. At 612, the command module 412 determines the errors and the first linear and angular velocity commands, as discussed above.

At 616, the second error module 420 determines the linear and angular velocity errors between the actual and commanded linear and angular velocities, respectively, as discussed above. At 620, the PI module 432 determines the adjusted linear and angular velocity commands based on the errors using PI control, as discussed above. At 624, the driver module 440 applies power (e.g., from one or more batteries) to the electric motor(s) 208 of the follower AMR 108 based on the adjusted linear and angular velocity commands to adjust the linear and angular velocity errors toward or to zero.

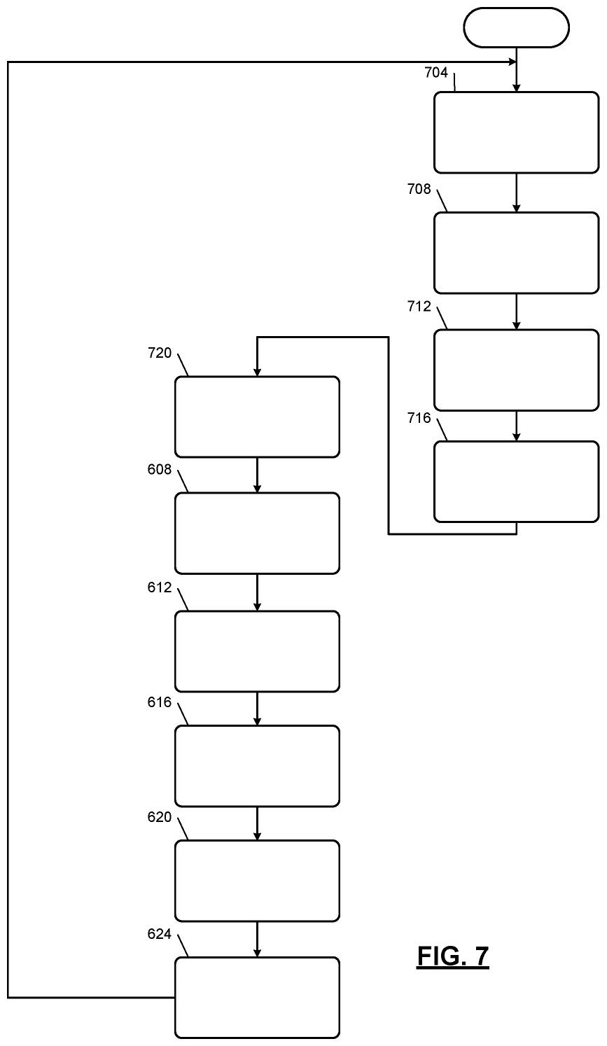

FIG. 7 is a flowchart depicting an example method of controlling the leader and follower AMRs 104 and 108. Control begins with 704 where the leader velocity module 504 determines the linear and angular velocity commands for the leader AMR 104. At 708, the error module 508 determines the errors between the actual linear and angular velocities and the linear and angular velocity commands, respectively, as discussed above. At 712, the PI module 512 determines the adjusted linear and angular velocity commands for the leader AMR 104 based on the errors using PI control, as discussed above.

At 716, the driver module 516 applies power (e.g., from one or more batteries) to the electric motor(s) 524 of the leader AMR 104 based on the adjusted linear and angular velocity commands to adjust the linear and angular velocity errors toward or to zero. At 720, the first error module 404 receives the leader position and heading from the position module 520 of the leader AMR 104 and the follower position and heading angle from the position module 220 of the follower AMR 108. Control continues with 608-624 as discussed above to control the follower AMR 108. In various implementations, 704-716 and 608-624 may be performed in parallel such that the leader AMR 1045 and the follower AMR 108 are controlled concurrently.

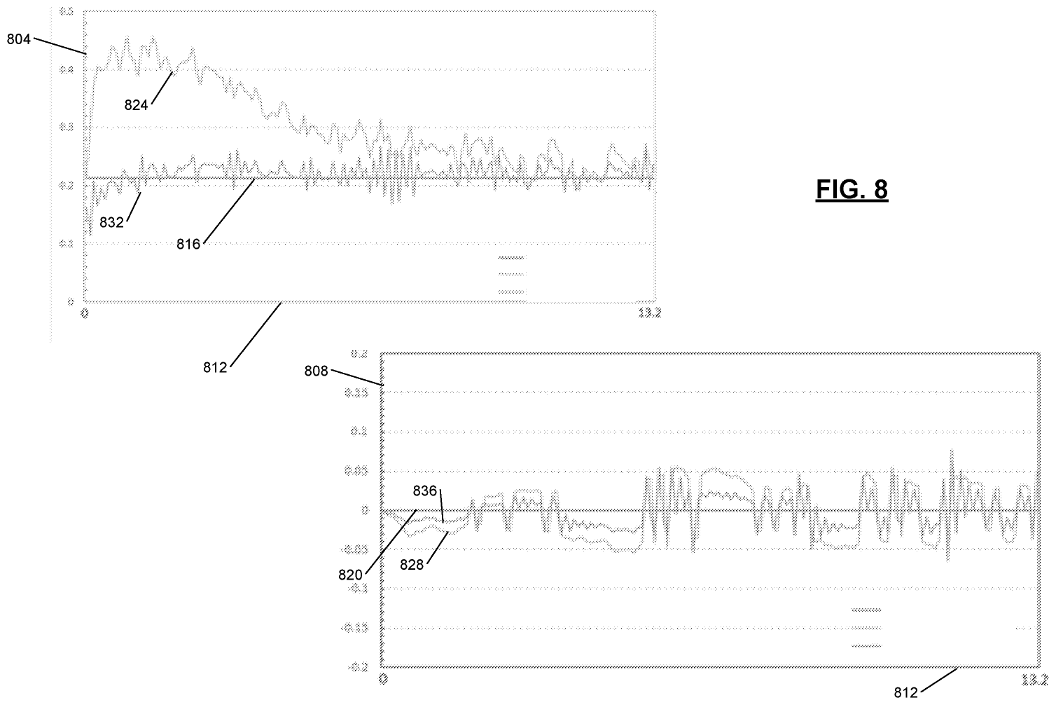

FIG. 8 includes example graphs of linear velocity 804 and angular velocity 808 as a function of traveling distance 812. Traces 816 and 820 track the linear and angular velocity, respectively, of the leader AMR 104. In the example of FIG. 8 these values were kept constant.

Traces 824 and 828 track the linear and angular velocity, respectively, of the follower AMR 108 if the PI module 432 was omitted. Traces 832 and 836 track the linear and angular velocity, respectively, of the follower AMR 108 controlled according to the example of FIG. 4. As illustrated, the example of FIG. 4 allows the follower AMR 108 to more closely and more quickly follow the leader AMR 104. The example of FIG. 5 would provide even better control.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems (e.g., Robot Operating System (ROS), Linux, Windows, etc.), user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A control system for one or more autonomous mobile robots, the control system comprising:
a command module configured to generate a first linear velocity command and a first angular velocity command for a follower autonomous mobile robot (AMR) of a swarm of two or more AMRs including at least the follower AMR and a leader AMR;
an error module configured to:
generate a first error for the follower AMR between the first linear velocity command and a present velocity of the follower AMR; and
generate a second error for the follower AMR between the first angular velocity command and a present angular velocity of the follower AMR;
a proportional integral (PI) module configured to:
generate a second linear velocity command for the follower AMR based on the first error using PI control; and
generate a second angular velocity command for the follower AMR based on the second error using PI control; and
a driver module configured to apply power to one or more electric motors of the follower AMR based on the second linear velocity command and the second angular velocity command.

2. The control system of claim 1 wherein the command module is configured to generate at least one of the first linear velocity command and the first angular velocity command based on distances between positions of the leader AMR and a positions of the follower AMR.

3. The control system of claim 2 wherein the command module is configured to generate at least one of the first linear velocity command and the first angular velocity command further based on a difference between a heading angle of the leader AMR and a heading angle of the follower AMR.

4. The control system of claim 2 further comprising a position module configured to determine the positions of the follower AMR using a light detection and ranging (LI DAR) sensor.

5. The control system of claim 1 further comprising sensors configured to measure the present angular velocity of the follower AMR and the present linear velocity of the follower AMR.

6. The control system of claim 1 wherein the leader AMR includes a second driver module configured to apply power to one or more electric motors of the leader AMR based on predetermined linear and angular velocity commands.

7. The control system of claim 1 wherein the leader AMR includes a second driver module configured to apply power to one or more electric motors of the leader AMR based on following a predetermined path.

8. The control system of claim 1 wherein the leader AMR includes:
a second error module configured to:
generate a third error for the leader AMR between a third linear velocity command and a present velocity of the leader AMR; and
generate a fourth error for the leader AMR between a third angular velocity command and a present angular velocity of the leader AMR;
a second PI module configured to:
generate a fourth linear velocity command for the leader AMR based on the third error using PI control; and
generate a fourth angular velocity command for the follower AMR based on the fourth error using PI control; and
a second driver module configured to apply power to one or more electric motors of the follower AMR based on the fourth linear velocity command and the fourth angular velocity command.

9. The control system of claim 8 wherein the leader AMR further includes a leader velocity module configured to generate the third linear velocity command for the leader AMR and the third angular velocity command for the leader AMR.

10. The control system of claim 9 wherein the leader velocity module is configured to generate the third linear velocity command and the third angular velocity command based on predetermined linear and angular velocity commands.

11. The control system of claim 9 wherein the leader velocity module is configured to generate the third linear velocity command and the third angular velocity command based on following a predetermined path.

12. A control method for one or more autonomous mobile robots, the control method comprising:
generating a first linear velocity command and a first angular velocity command for a follower autonomous mobile robot (AMR) of a swarm of two or more AMRs including at least the follower AMR and a leader AMR;
generating a first error for the follower AMR between the first linear velocity command and a present velocity of the follower AMR;
generating a second error for the follower AMR between the first angular velocity command and a present angular velocity of the follower AMR;
generating a second linear velocity command for the follower AMR based on the first error using proportional integral (PI) control;
generating a second angular velocity command for the follower AMR based on the second error using PI control; and
applying power to one or more electric motors of the follower AMR based on the second linear velocity command and the second angular velocity command.

13. The control method of claim 12 further comprising generating at least one of the first linear velocity command and the first angular velocity command based on distances between positions of the leader AMR and a positions of the follower AMR.

14. The control method of claim 13 further comprising generating at least one of the first linear velocity command and the first angular velocity command further based on a difference between a heading angle of the leader AMR and a heading angle of the follower AMR.

15. The control method of claim 13 further comprising determining the positions of the follower AMR using a light detection and ranging (LIDAR) sensor.

16. The control method of claim 12 further comprising measuring the present angular velocity of the follower AMR and the present linear velocity of the follower AMR using sensors.

17. The control method of claim 12 further comprising applying power to one or more electric motors of the leader AMR based on predetermined linear and angular velocity commands.

18. The control method of claim 12 further comprising applying power to one or more electric motors of the leader AMR based on following a predetermined path.

19. The control method of claim 12 further comprising:
generating a third error for the leader AMR between a third linear velocity command and a present velocity of the leader AMR;
generating a fourth error for the leader AMR between a third angular velocity command and a present angular velocity of the leader AMR;
generating a fourth linear velocity command for the leader AMR based on the third error using PI control;
generating a fourth angular velocity command for the follower AMR based on the fourth error using PI control; and
applying power to one or more electric motors of the follower AMR based on the fourth linear velocity command and the fourth angular velocity command.

20. The control method of claim 19 further comprising generating the third linear velocity command for the leader AMR and the third angular velocity command for the leader AMR.
